(19) United States
(12) Patent Application Publication
(10) Pub. No.: US 2007/0242744 A1
(43) Pub. Date: Oct. 18, 2007

(54) System and Method of Packet Recovery Using Partial Recovery Codes

(75) Inventors: Hayder Radha, East Lansing, MI (US); Shirish S. Karande, East Lansing, MI (US)

Correspondence Address: HARNESS, DICKEY & PIERCE, P.L.C., P.O. BOX 828, BLOOMFIELD HILLS, MI, 48303, US

(73) Assignee: Board of Trustees of Michigan State University, East Lansing, MI (US)

(21) Appl. No.: 11/628,344

(22) PCT Filed: Jun. 29, 2005
(86) PCT No.: PCT/US05/23437

§ 371 Date: Dec. 1, 2006

Related U.S. Application Data
(60) Provisional application No. 60/585,798, filed on Jul. 2, 2004.

(51) Int. Cl. H04L 1/00

(52) U.S. Cl. 375/240

(57) ABSTRACT

A coding system and method employs a Partial Reed Solomon (PRS) code profile of order s having an s-partition on a set of parity symbols and a (s+1)-partition on a set of message symbols. In other aspects, an adaptive forward error correction scheme keeps block length and transmission rate fixed, while changing an underlying code profile based on received feedback information about a probability of erasure p from a channel.

### FIELD OF THE INVENTION

The present invention generally relates to packet recovery for use with packet networks, and relates in particular to partial recovery of lost packets and their use in applications that can tolerate partial packet loss, such as audio and video media.

### BACKGROUND OF THE INVENTION

The unprecedented demand for data communications over unreliable systems, such as the Internet and wireless networks, has made linear block codes (LBC) increasingly popular within the past decade. In particular, modern Internet and wireless applications have employed these codes for unicast and multicast transmission of realtime multimedia and other non-realtime data types over erasure channels. These applications range from unicast telephony and receiver-driven multicast of multimedia data using traditional Reed-Solomon (RS) codes to reliable multicast of data files using low-density codes.

In principle, one can classify the type of applications that employ linear block codes into realtime and non-realtime. Each of these application types has its own requirements, constraints, and also flexibilities that can be exploited for a successful deployment of block codes over erasure channels. For example, a successful usage of the flexibilities and requirements of non-realtime applications that demand a reliable transmission of large data files to a large number of receivers has resulted in the recently developed digital fountain approach.

On the other hand, the majority of recent proposals for the recovery of lost packets encountered in realtime multicast and unicast applications are based on traditional RS codes. Some of these approaches are based on employing feedback information regarding the channel condition in realtime. Meanwhile, there are several key requirements and flexibilities imposed/provided by realtime applications that have not been fully considered/utilized when designing block codes for these applications.

One disadvantage of classical linear block codes, such as Reed-Solomon (RS)-based codes, is that they fail to recover any lost message symbols when the total losses exceed the redundant symbols. Under adverse channel conditions, situations where losses are greater than redundancy can often be possible. As a result, RS-based codes can often fail catastrophically when used with real-time multimedia applications under adverse conditions. Accordingly, multi-media stream generators typically take a conservative approach, and transmit a high number of redundant packets. This increase in packet transmission contributes to packet network congestion, thus exacerbating the adverse conditions. The result is a fierce competition between multi-media content providers for network bandwidth resources. Thus the need remains for a packet recovery technique that avoids catastrophic failure, thereby reducing the need for redundant packet transmission and conserving packet network resources. The present invention fulfills this need.

### SUMMARY OF THE INVENTION

In accordance with the present invention, a coding system and method employs a Partial Reed Solomon (PRS) code profile of order s having an s-partition on a set of parity symbols and a (s+1)-partition on a set of message symbols. In other aspects, an adaptive forward error correction scheme keeps block length and transmission rate fixed, while changing an underlying code profile based on received feedback information about a probability of erasure p from a channel.

The Partial Recovery Codes of the present invention are advantageous over previous recovery codes because they exhibit improved performance over classic Reed Solomon codes when the coding rate is close to channel capacity, and avoid catastrophic failure in the case where the total losses exceed the redundant symbols. Partial packet recovery is accomplished for real-time multimedia even where the number of losses exceeds the number of redundant packets. These Partial Recovery Codes facilitate a partial recovery of lost symbols, and are specifically designed and optimized for real-time multimedia communication over packet-based erasure channels. Their efficient design is facilitated by lowering the density and increasing irregularity. Accordingly, based on the constraints and flexibilities of realtime applications, a performance measure is designed, message throughput (τₘ), which is suitable for these applications. This measure differentiates the notion of optimum codes for the target multimedia applications which can tolerate some packet loss, as compared to performance measures that are used for non-realtime applications that require guaranteed reliability. Based on the proposed throughput measure, the advantages of lowering the density of a code for near capacity performance are combined with the high decoding efficiency of Reed Solomon (RS) codes, in order to design optimum partial Reed-Solomon (PRS) codes. An example of a Binary Erasure Channel (BEC) demonstrates that at near-capacity coding rates, appropriate design of a PRS code can outperform an RS code. This analysis and optimization is extended for a general BEC over a wide range of channel conditions. Moreover, as compared with RS codes, the proposed PRS codes provide a significantly improved graceful degradation when the number of losses exceeds the number of parity symbols within the code block. This is a highly desirable feature for realtime multimedia communication. Video simulations carried out using H.264 compressed video further emphasize the utility of this graceful degradation. Finally a paradigm is set for a unique rate constrained adaptive FEC scheme based on PRS codes. This scheme is compared with other adaptive rate constrained schemes based on RS codes.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is block diagram of a PRS code, with s being the order of the code, and the code being made up of (s+1) subcodes formed by a s-partition on a set of parity symbols and a (s+1)-partition on a set of message symbols, wherein it should be noted that Kₛ₊₁ message symbols are transmitted without any protection;

FIG. 2(a) is a block diagram of a set of PRS codes containing all order 1 and order 2 PRS codes;

FIG. 2(b) is a block diagram of a set of PRS codes containing all order 1 PRS codes and only those order 2 PRS codes which do contain any unprotected message symbols;

FIG. 3 is a block diagram illustrating conversion of a order (s+1) PRS code into a better order s PRS code using Proposition 2;

FIG. 4(a) is a three-dimensional graph illustrating message throughput of codes belonging to the set Ψ_{100,88,0} as a function of K1 (x-axis on the right) and N1−K1 (y-axis on the left) for block size N=100, number of message symbols K=88, and loss probability ρ=0.05; 4

FIG. 4(b) is a three-dimensional graph illustrating message throughput of codes belonging to the set Ψ_{100,88,0} as a function of K1 (x-axis on the right) and N1−K1 (y-axis on the left) for block size N=100, number of message symbols K=88, and loss probability ρ=0.1;

FIG. 4(c) is a three-dimensional graph illustrating message throughput of codes belonging to the set Ψ_{100,88,0} as a function of K1 (x-axis on the right) and N1−K1 (y-axis on the left) for block size N=100, number of message symbols K=88, and loss probability ρ=0.15;

FIG. 4(d) is a three-dimensional graph illustrating message throughput of codes belonging to the set Ψ_{100,88,0} as a function of K1 (x-axis on the right) and N1−K1 (y-axis on the left) for block size N=100, number of message symbols K=88, and loss probability ρ=0.20;

FIG. 5 is a three-dimensional graph illustrating performance of an optimal PRS-1 code with block size N=100;

FIG. 6 is a three-dimensional graph illustrating dependence of optimal K₁ with block size N=100;

FIG. 7 is a three-dimensional graph illustrating the difference in performance of RS code and an optimal PRS-1 code in terms of message throughput;

FIG. 8 is a two-dimensional graph illustrating message throughput performance of optimum (N, K, K*)=(100, 88, K*) PRS codes as compared with the RS (N, K)=(100,88) code over different Binary Erasure Channel (BEC) conditions, wherein the coding rate K/N is lower than the channel capacities, demonstrating that the optimum PRS codes maintain better overall message throughput under these conditions and much better performance for coding rates beyond channel capacity;

FIG. 9 is a two-dimensional graph illustrating percent recovery of dropped message packets, (N, K, K*)=(100, 88, K*) PRS codes as compared with the RS (N, K)=(100,88) code over different Binary Erasure Channel (BEC) conditions, demonstrating that PRS codes recover more erased data than RS codes;

FIG. 10 is a two-dimensional graph comparing recovery capabilities of codes optimized for different channel conditions,

FIGS. 11A and 11B are view of particular ensemble simulations each showing in a clockwise manner an instance in the foreman Sequence for L=12 RS code, L=12 PRS-1 code optimized for p=0.11, L=13 PRS-1 code optimized for p=0.11, L=13 RS code;

FIG. 12 is a block diagram illustrating a transmission rate constrained scheme based on RS codes, demonstrating that Kdrop message packets can be dropped at the source to facilitate extra bandwidth to send extra Kdrop parity packets, such that the remaining data can be transmitted in a robust manner at the expense of dropping some data at the source; and

FIG. 13 is a two-dimensional graph comparing (100,88) optimal PRS-1 with (100,88) RS, (100,K*) RS, and (100,100 p) RS for coding rate greater than channel capacity.

### DETAILED DESCRIPTION OF THE PREFERRED EMBODIMENTS

The following description of the preferred embodiment(s) is merely exemplary in nature and is in no way intended to limit the invention, its application, or uses.

The present invention takes into consideration key requirements and flexibilities of multimedia applications, in general, and realtime compressed video transmission in particular to introduce and design a family of linear block codes that can outperform traditional RS codes. Specifically, a new family of codes is introduced, referred to herein as Partial Reed Solomon (PRS) codes. The proposed PRS codes can be considered a lower-density version of the classical RS codes. It has been observed that low density codes can give near channel capacity performance. As the coding rate approaches channel capacity, lowering the density of a code becomes a necessity, in particular, for realtime applications. Meanwhile, the decoding efficiency (or recovery ratio) offered by an RS code is greater than any other linear code. Thus, the proposed PRS codes are based on a framework that combines the advantage of lowering density with the high decoding efficiency of traditional RS codes.

The rest of the application is structured as follows: In Section II, the constraints and the flexibilities associated with realtime multimedia transmission are identified. Based on this, a performance measure is identified that is more suitable for FEC schemes that are targeted for realtime multimedia applications. In Section III, the proposed family of PRS linear block codes are introduced, which as explained further in the application, can be characterized by a certain order. In Section IV optimal PRS codes are identified for a Binary Erasure Channel and it is shown that the optimal PRS codes are of order one. This optimum class of PRS is referred to as PRS-1 codes. In Section V, some further optimality analysis of the PRS-1 codes is provided. Some results exhibiting the performance of these codes under various channel conditions are provided. In Section VI the performance of PRS-1 codes is compared with that of RS codes. In Section VII, the performance of the two codes is compared in terms of graceful degradation. In Section VIII, results of actual video simulations and a subjective comparison of media quality supported by the two coding schemes are provided. In Section IX, a case is made for designing adaptive FEC schemes based on PRS-1 codes for time-varying channels.

II. Realtime Applications: Constraints and Flexibilities

A fundamental requirement of any realtime application is the transmission of message data at a minimum desired rate R. In general, this minimum rate should be maintained to achieve a certain quality. The minimum rate requirement translates to the transmission of a minimum number of K message symbols within an N-symbol code block: R=K/N. Consequently, one of the constraints in the design of linear block codes for realtime applications is the usage of a maximum number (N−K) of parity symbols within the N-symbol block.

In general, the performance of linear block codes improves with larger values of the code block size N. However, realtime applications can employ a maximum number N depending on the particular application. For example, non-interactive multimedia streaming applications can use larger values of N than interactive (e.g., telephony) applications. In either case, there is a maximum number for the code block size N that needs to be adhered to. Therefore, unlike non-realtime applications that may have the flexibility in selecting N and R=K/N, realtime applications, in general, have to employ (adhere to) a block code with a pair-constraint (N, K).

Performance criteria for LBC codes, which are used for non-realtime data, are not always suitable for realtime applications. For example, a non-realtime LBC code can be evaluated based on the number of symbols needed to perfectly recover all of the original message symbols. In general, for realtime applications, perfect recovery, and consequently perfect reconstruction, of the original message symbols is not a hard requirement (as explained further below). Meanwhile, it is crucial to deliver the realtime application layer with the maximum number of the message symbols that are transmitted by the system. Therefore, the probability of a message symbol loss (after channel decoding) is a key performance parameter. This probability is denoted by pₘ. Hence, the parameter τₘ=(1−pₘ), which represents the probability of receiving a message symbol by the realtime application (after channel decoding), is a measure of the end-to-end message symbol throughput. One of the key objectives of the family of PRS codes that are proposed in this application is to maximize this throughput measure τₘ. (For the remainder of this application, τₘ is referred to as the message throughput.)

Moreover, based on a variety of multimedia processing, compression, and scalable coding techniques, a wide range of practical application-layer error resilience and concealment methods can be used to compensate for lost data. These techniques, however, usually work well only when the number of losses is limited to a certain threshold. In other words, practical multimedia error concealment and resilience methods usually become useless when the number of losses is beyond an application-dependent threshold. Consequently, it is very crucial for LBC codes to perform well when the number of lost message symbols is large by recovering the majority of these lost message symbols. Meanwhile, and although it is desirable, it is less crucial for these codes to provide perfect recovery when the number of losses (before or after channel decoding) is very small (e.g., one or few symbols) due to the maturity of powerful multimedia processing techniques. Therefore, codes that maintain very low end-to-end (effective) message losses are-more desirable than codes that provide perfect recovery under good channel conditions (e.g., under very low loss probability) but provide low recovery rate under adverse channel conditions. This desirable feature highlights one of the key problems with current LBC codes that are used widely for realtime video. It is well known, for example, that when a RS code block experience a number of losses that is larger than the number of parity symbols, then the code is incapable of recovering any of the lost message data. Experiencing a number of losses that is larger than the number of parity symbols is quite feasible over channels with time-varying characteristics (e.g., the Internet and wireless networks), even if, “on average”, the message rate R is lower than the channel capacity. This is particularly true when the message rate R is close to (but may still be lower than) the channel capacity. Moreover, and due to: (a) the large amount of data that is inherently needed for representing multimedia (in particular video) signals, and/or (b) the compressed representation of these signals is normally encoded ahead of time at a certain minimum rate that cannot be further reduced in realtime by the sender, it is quite often when multimedia applications operate very closely to channel capacity. This phenomenon is quite common for a wide range of applications such as popular streaming applications on the web, IP multimedia telephony, and IP multicast.

Consequently, one of the main objectives of the proposed work is the design of LBC codes that are capable of achieving high message throughput τₘ when the rate is close to (but still lower than) channel capacity. Unlike traditional RS codes, which exhibit a very sharp degradation in their ability to recover lost packets around the point (L=N−K), and as shown in this application, the proposed PRS codes provide a graceful transition in their lost-message-recovery capabilities while maintaining a very high message throughput τₘ over this transition point and beyond.

III. Partial Reed Solomon Codes

Before introduction of the family of PRS codes, the role density plays in the design of codes is first discussed. This will clearly outline the significance of the design of PRS codes.

It is well known that all linear block codes could be represented by bipartite graphs, where the vertex set can be partitioned into message nodes and parity nodes. Codes based on GF(2) can be represented by graphs. Similarly codes in GF (q), where q represents the order of the underlying field, where q>2, can also be represented by graphs, but in this case the edges are weighted by elements from GF (q). Thus, it is possible to represent an RS code also by an edge-weighted bipartite graph. However, in this case, the graph representing an RS code would be a full density (i.e., complete) graph. It should be noted that, the code-graph can be represented such that the message and the redundancy symbols belong to the same partition and all the nodes in the parity-check partition are made equal to zero. However, in the above case, the assumed graph representation is such that, the redundancy and the message do not belong to the same partition and thus the checks can have actual non-zero values. Only for such a representation can the RS-graph be termed as full-density.

The decoding of a codeword transmitted over an erasure channel is equivalent to solving a system of equations, represented by the parity check equations. The erased symbols represent the unknowns in the system of equation. Thus for a given (N,K) and a given density, as the probability of channel erasure p increases, the average number of unknowns in each parity check equation also increases. Also, as the number of unknowns in a parity check equation increases, the probability of that equation being successfully solved decreases. Due to this, when the coding rate is near (or above) channel capacity, it becomes necessary to reduce the number of message symbols that are protected by each parity symbol. This is equivalent to reducing the density of the code.

The iterative algorithms used for erasure decoding of current LDPC codes, limit each sub-step of an iteration to solving a single equation with a single unknown. This constraint has influenced the design of most of the current LDPC codes. If a code is based on GF(2), then the above constraint is not a severe one. But, for codes based on GF(q), the above constraint, can lead to an over-compromise of the decoding efficiency for reduced time-complexity. Moreover, it has been shown that codes designed on fields higher than (2) GF(2), can exhibit a much-improved performance in terms of error recovery. In addition, since a packet loss causes a burst of bit erasures, a code based on larger symbols can facilitate a better data recovery. Since a key objective of the effort is to maximize the message throughput (i.e., lost-symbol recovery), code-design is not constrained to graphs without cycles, and the decoding algorithm is not constrained to solving only “single unknown” equations.

Meanwhile, decoding algorithms for a general code based on GF(q), can have a very high time complexity. Thus, it is advantageous to limit the code design to a family of codes, where the entire codeword can be broken down into sub-codes that resemble RS codes. This allows us to use algorithms developed for efficient decoding of RS codes, for decoding of these RS based sub-codes. Decoding of individual sub-codes can facilitate the decoding of the entire codeword. However, for ease of analysis the subcodes are designed such that the message symbols are mutually exclusive. It should be noted that a code design that allows sub-codes to overlap does not necessarily lead to a performance improvement. Moreover a code-design, which as described above does not allow a sub-code overlap, does not require multiple iterations for decoding and thus can lead to reduced time complexity. It is envisioned, however, that more generalized designs may be accomplished that allow sub-code overlap and/or use multiple iterations for decoding. After this brief discussion of the significance of the proposed PRS codes, the general structure of these codes is introduced.

For a given realtime-pair constraint (N, K), a general PRS code of order s is denoted by (N, K, Λₛ)_{q} where Λₛ represents a 2×(s+1) matrix given by:

$$[ \begin{matrix}{N}_{1} … {N}_{s + 1} \\ {K}_{1} … {K}_{s + 1}\end{matrix} ] .$$

In all further discussions, q is dropped from the notation and the order of the field on which the code is based is assumed to have been pre-specified. Moreover, as long as q>N, the parameter q does not influence the performance of the FEC scheme. The entries of matrix Λₛ are constrained by the equations in (1):

$${N}_{i} > {K}_{i} ∀ i ∈ [ 1 , s ] , \\ {K}_{i} > 0 ∀ i ∈ [ 1 , s ] , \\ {N}_{s + 1} = {K}_{s + 1} and N = {\sum }_{i} {N}_{i} , K = {\sum }_{i} {K}_{i} . \qquad ( 1 )$$

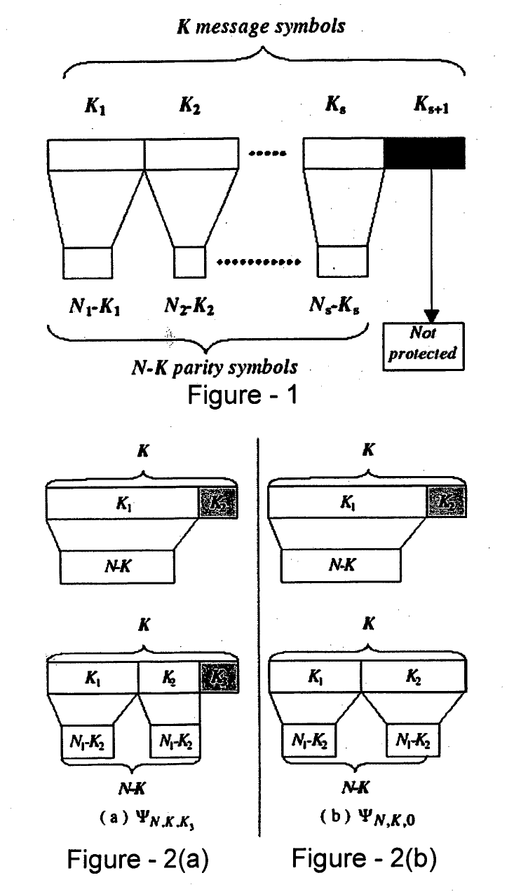

Thus Λₛ gives an s-partition on the set of parity symbols and a (s+1)-partition on the set of message symbols. FIG. 1 shows an example of such a order s PRS code. The code is designed such that ∀iε[1,s], the pair (Nᵢ,Kᵢ) forms an RS-subcode over GF(q). Kₛ₊₁ number of message symbols are transmitted without any protection. This can be interpreted to be equivalent to a trivial rate 1 RS code. Thus the code-graph can be divided into (s+1) disjoint sub-graphs. Obviously such a code graph does not have full density and the density of the overall code has been lowered. A PRS code with Nₛ₊₁=K_{s+1 =0} does not include any subset of message symbols that are not protected. It should be noted that an order 1 (s=1) PRS code with N₂=K₂=0 is equivalent to the traditional full density RS code.

Thus the average total message throughput of an order s PRS code is given by

$${τ}_{m} = ( \frac{1}{K} ) \cdot {\sum }_{i = 1}^{s + 1} ρ ( {N}_{i} , {K}_{i} ) \qquad ( 2 )$$

where, ρ(Nᵢ,Kᵢ) denotes the average number of message symbols received after channel decoding due to a single component of the code graph and can be evaluated using the following equation

$$ρ ( {N}_{i} , {K}_{i} ) = ( {\sum }_{l = 0}^{{N}_{i} - {K}_{i}} {K}_{i} \cdot ( \begin{matrix}{N}_{i} \\ l\end{matrix} ) \cdot {p}^{l} \cdot {( 1 - p )}^{( {N}_{i} - l )} ) + ( {\sum }_{l = {N}_{i} - {K}_{i} + 1}^{{N}_{i}} ( {K}_{i} / {N}_{i} ) \cdot ( {N}_{i} - l ) \cdot {p}^{l} \cdot {( 1 - p )}^{( {N}_{i} - l )} ) . \qquad ( 3 )$$

IV. Optimal PRS Codes

This section identifies the class of optimal PRS codes for a Binary Erasure Channel (BEC). It is shown that, for a BEC, the optimal PRS code is given by an order 1 PRS code (i.e., PRS-1). The parameter used to measure performance of a code here is message throughput. Thus a code that maximizes this parameter will be the optimal code. At this stage some lemmas are proven; these lemmas help to limit the ensemble of codes that have to be considered to find the optimal PRS code. The following notations and propositions are used by the lemmas.

Let,
Ψ_{N,K,K}_{₃}
as shown in FIG. 2 (a), be a set containing all PRS codes of order 1 with

$${Λ}_{1} = [ \begin{matrix}{N}_{1} & {K}_{2} \\ {K}_{1} & {K}_{2}\end{matrix} ]$$

and all PRS codes of order 2 with

$${Λ}_{2} = [ \begin{matrix}{N}_{1} & {N}_{2} & {K}_{3} \\ {K}_{1} & {K}_{2} & {K}_{3}\end{matrix} ] .$$

An example of
Ψ_{N,K,K}_{₃}
   is the set
Ψ_{N,K,0}
   as shown in FIG. 2 (b). In addition to all possible PRS codes of order 1,
Ψ_{N,K,0}
   includes only a subset of all PRS codes of order 2 (i.e., PRS-2). This subset represents PRS-2 codes where each message symbol is protected by at least one parity symbol. In other words, no message symbols in this particular PRS-2 subset, which is included in
Ψ_{N,K,0}
   is left unprotected.

Below three propositions are used to prove the lemmas regarding the optimality of PRS codes of order s=1.

Proposition 1 (P1): ∀ (N,K) the optimal PRS code in the set
Ψ_{N,K,0}
   is an order 1 PRS code.

Proposition 2 (P2): ∀ (N,K), ∀ (N,K₃) the optimal PRS code in the set
Ψ_{N,K,K}_{₃}
   is an order 1 PRS code.

Proposition 3 (P3): ∀ (N,K), ∃ an order s PRS code, that performs better than all order (s+1) PRS codes.

LEMMA 1: For a BEC P1 [symbol] P2. In other words, if the optimal code within the set
Ψ_{N,K,0}
   is a PRS-1 code, then the optimal code in the more general set
Ψ_{N,K,K}_{₃}∀K₃<K,
   is also a PRS-1 code.

Proof Consider the optimal code on the set
Ψ_{(N-K}_{₃}_{), (K-K}_{₃}_{),0}.
   P1 implies that the optimal PRS code on this set is a PRS code of order 1. Since adding unprotected symbols to a block will not change the relative performance of two codes on a BEC, the optimal PRS code in the set
Ψ_{N,K,K}_{₃}
   is also an order 1 PRS code. Thus for a BEC P1 [symbol] P2.

LEMMA 2: For a BEC P2 [symbol] P3.

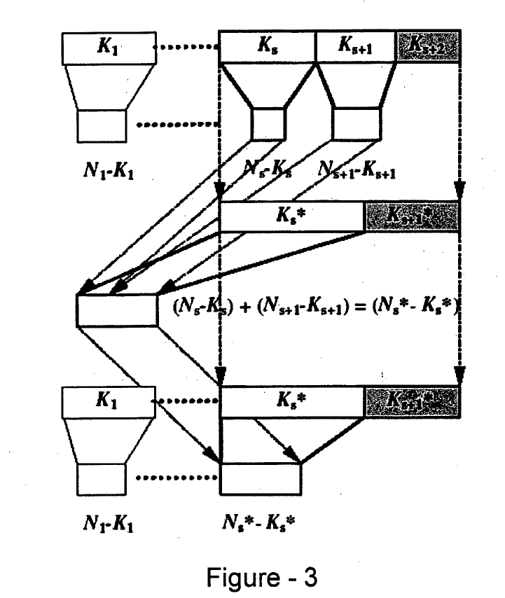

Proof: Consider a PRS code of order (s+1) be given by (N,K,Λₛ₊₁) as shown in FIG. 3. Using P2 it is possible to conclude that the optimal PRS code in
Ψ_{(N}_{+N}₊₁_{),(K}_{+K}_{ₛ₊₁}_{+K}_{ₛ₊₂}_{),K}_{₊₂}
is an order 1 PRS code. For a BEC the relative performance of two codewords does not change due to the addition of identical code sections. Thus FIG. 3 shows that using P2 any order (s+1) PRS code can be converted into a better (increase message throughput) order s PRS code. Thus even the optimal PRS (s+1) PRS code can be improved upon by some order s PRS code. Therefore it is possible to conclude that for a BEC P2 [symbol] P3.

LEMMA 3: For a BEC P2 [symbol] P3.

Lemma's 1 and 2 reduce the ensemble of codes over which there is a need to search for an optimal code to the set
Ψ_{N,K,0}. Now, experimental evidence is presented that allows formulation of the following conjecture.

CONJECTURE 1: For a BEC channel P1 is true.

The validity of conjecture 1 is verified for different values of N, K and p. Here, some results for N=100 and K=88 are presented. Any PRS code of order 2 belonging to the set
Ψ_{100,88,0}
can be represented by

$${Λ}_{2} = [ \begin{matrix}{N}_{1} & N - {N}_{1} & 0 \\ {K}_{1} & K - {K}_{1} & 0\end{matrix} ] .$$

In other words, for a given (N, K), only two parameters (e.g., N1 and K1) are needed to represent all codes in the set
Ψ_{N,K,0}.
Moreover, the search space to find the optimal PRS code can be further reduced by noting that the performance of the above PRS code will be unchanged even if

$${Λ}_{2} = [ \begin{matrix}N - {N}_{1} & {N}_{1} & 0 \\ K - {K}_{1} & {K}_{1} & 0\end{matrix} ] .$$

Thus the values of N₁ and K₁ are constrained by the following equations:
(N₁−K₁)≧┌(N−K)/2┐.

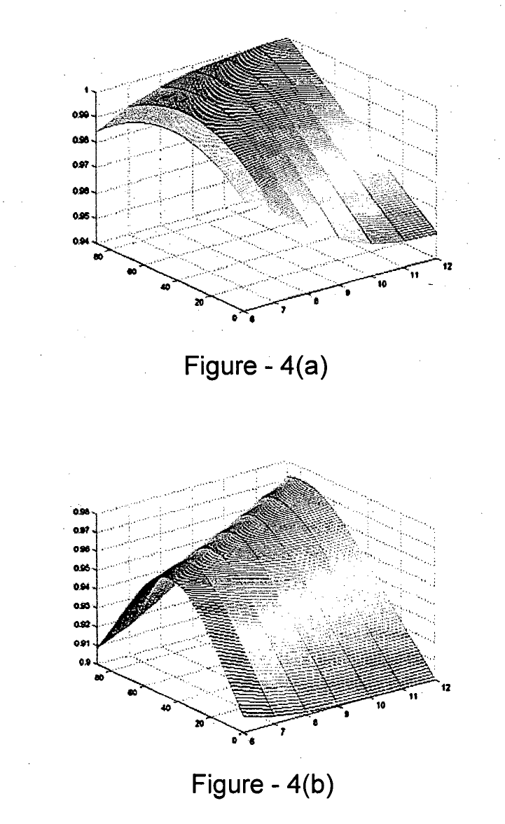

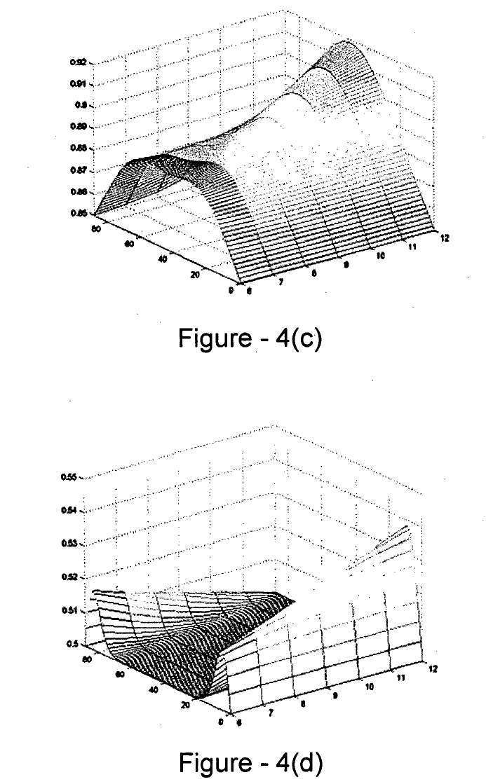

Thus in FIG. 4 (a)-(d) the x-axis shows the value of (N₁−K₁), the y-axis shows the value of K₁ and the z-axis shows the message throughput of the corresponding code. The probability of erasure p, is the parameter for which the code is optimized. In each figure, P1 is validated if the code that has maximum message throughput satisfies the condition N₁−K₁=N−K. This represents a PRS-1 code since all the parity symbols are being allocated to protect only one subset (with K₁ elements) of the message symbols. The other subset of message symbols (with K−K₁ elements) is either empty (i.e., K−K₁=0) or not protected at all. In the case when K−K₁=0, the result is a traditional RS code where all of the message symbols are protected by all the parity symbols.

FIGS. 4 (a) and (b) show the results for p=0.05 and p=0.1 where the channel capacity is 0.95 and 0.90, respectively. It should be noted that in both of these cases the coding rate (0.88) is below channel capacity. It can be seen in that in both the cases the optimal PRS code for a BEC in
Ψ_{100,88,0}
   is an order 1 PRS code. Thus using lemma 3 it can be concluded that for a BEC the optimal code is given by PRS code of order 1. In FIG. 4 (a) it can be seen that the optimal code is actually a RS code. Thus it is possible that the optimal PRS code turns out to be a RS code depending on the channel condition. Meanwhile, it should be noted that in FIG. 4 (b), though the coding rate is lower than the channel capacity, the optimal code is given by a PRS code of order 1 that is not equivalent to a RS code. Thus an optimal PRS code, on account of being an order 1 code, can be parameterized by K₁ which denotes the total number of message symbols that are protected in a codeword.

It has been explained above in section II, that though “on-average” the coding rate is lower than channel capacity, the time varying nature of a channel can make the scenarios when the number of losses are greater than N−K, or when the coding rate is higher than channel capacity possible. In such a situation though complete recovery of lost data is impossible, partial recovery can be provided even when the coding rate is greater than channel capacity. Thus a possible way to mitigate the above problem is to use some feedback information to change the code profile. Section IX presents a unique “fixed rate” adaptive FEC scheme based on PRS-1 codes which adaptively facilitates such a partial recovery under severe channel conditions. For this purpose it is important to conduct optimality analysis of PRS codes for coding rates greater than channel capacity. The FIGS. 4 (c) and (d) exhibit the performance of PRS codes belonging to
Ψ_{100,88,0}
   for p=0.15 and p=0.2, where the channel capacity is 0.85 and 0.80, respectively. It can be observed that even when the coding rate (0.88) is greater than channel capacity the optimal PRS code is of order 1.

Thus using Conjecture 1 and lemma 3 it can be concluded that for a BEC ∀(N K p), the optimal PRS code is an order 1 PRS code.

V. Optimal PRS-1

In this section, the performance of PRS codes of order 1 (PRS-1) are further evaluated and analyzed. As the design of a PRS code is completely determined by the choice of K₁, a shortened notation for order 1 PRS code is used. Thus a PRS code denoted by (N,K,K₁) is equivalent to a PRS code denoted by (N,K,Λ₁) where

$${Λ}_{1} = [ \begin{matrix}N - K + {K}_{1} & K - {K}_{1} \\ {K}_{1} & K - {K}_{1}\end{matrix} ] .$$

Thus the optimal PRS code will be obtained by choosing an optimal value of K₁, denoted by K*.

The probability of a message symbol loss (after channel decoding) for a (N,K,K₁) PRS-1 code over a BEC with probability of erasure p is given by

$${p}_{m} = ( 1 / K ) \cdot ( \begin{matrix}( K - {K}_{1} ) \cdot p + ( \frac{{K}_{1}}{( N - K ) + {K}_{1}} ) \cdot \\ ( {\sum }_{i = ( {N}_{1} - {K}_{1} ) + 1}^{{N}_{1}} i \cdot ( \begin{matrix}{N}_{1} \\ i\end{matrix} ) \cdot {p}^{i} \cdot {( 1 - p )}^{{N}_{1} - i} )\end{matrix} ) \\ where {N}_{1} = N - K + {K}_{1} \qquad ( 4 )$$

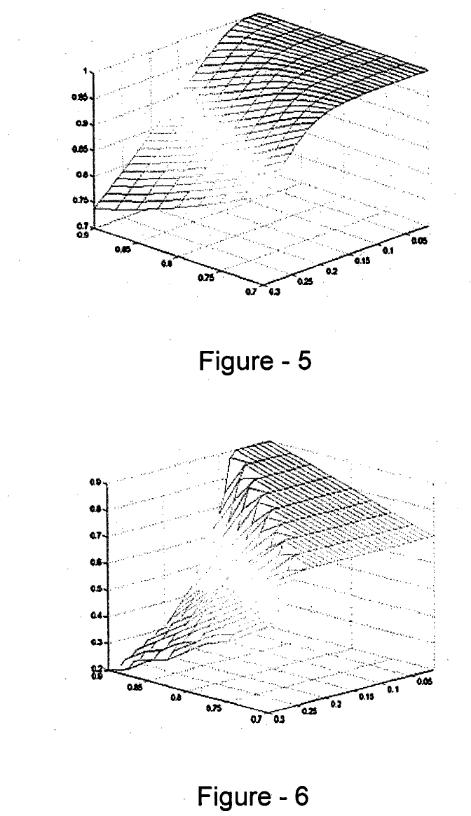

The optimal value of K₁ can be obtained by minimizing the above expression. Since τₘ=(1−τₘ), this is equivalent to maximizing the message throughput. Thus the results in FIGS. 5-7 are obtained by using the above equation. In FIGS. 8-10 the block-length of the code is chosen as N=100. For this block-length the behavior of the performance of optimal PRS-1 code and the behavior of the optimal value of K₁ is observed. In all of the three figures, the x-axis (on the left) shows the coding rate R=K/N and the y-axis (on the right) shows the probability of erasure p.

In FIG. 5 the z-axis shows the message throughput for the optimal PRS-1 code, while in FIG. 6 the z-axis shows the ratio K*/N for the corresponding optimal codes. It can be seen that for a given N the dependence of K* (and thus the performance of the optimal PRS-1 code) on the coding rate and (1−p) is symmetrical. It can be observed that for a given loss probability p, as the coding rate increases, the message throughput decreases. For coding rates below channel capacity the decrease in message throughput with increase in coding rate is very gradual, and the drop in performance when the coding rate is beyond channel capacity is very severe. Nevertheless, it can be observed that even for coding rates beyond channel capacity it is possible to get a reasonable message throughput and drop in performance that is graceful.

In FIG. 6 it can be observed that for coding rates less than channel capacity, for most of the range, the optimal PRS code is a RS code, since (K*/N)=R. For coding rates beyond channel capacity the ratio K*/N decreases at a fast rate. Thus as the coding rate increases the density of the code needs to be decreased to facilitate optimal decoding efficiency. It can be observed that the decrease in the value of K*/N with increasing coding rate despite being very fast maintains its gracefulness. This property can be utilized to obtain a closed form approximation of the dependence of K*/N on the coding rate and probability of erasure. A closed form approximation can facilitate a fast encoding scheme for near optimal PRS codes.

As the dependence of optimal PRS codes on channel capacity and coding rate is symmetric, it can be concluded that for a given probability of erasure and block-length there exists a critical coding rate lesser than channel capacity, such that, for all coding rates above this critical value, there exists an optimal PRS code that can outperform the traditional RS code. Moreover, it can be shown for the PRS-1 codes,

$$As N -> ∞ , {p}_{m} -> 1 - ( \frac{{K}_{1} + ( 1 - p ) ( K - {K}_{1} )}{K} ) , ⇒ \\ As N -> ∞ , {K}_{1} -> ( 1 - p ) \cdot ( {K}_{1} + ( N - K ) ) , ⇒ \\ As N -> ∞ , \\ {p}_{m} -> 1 - ( \frac{( 1 - p ) \cdot ( {K}_{1} + ( N - K ) ) + ( 1 - p ) \cdot ( K - {K}_{1} )}{K} )$$

$$i . e . as N -> ∞ , {p}_{m} -> ( \frac{( 1 - p ) \cdot N}{K} ) ,$$

Thus, since
N→∞,C→(1−p) and R=K/N,
it can be concluded that as
N→∞,pₘ→1−(C/R).

By combining the (inverse of the) channel coding theorem with this result, it can be concluded that as
N→∞,
   the critical rate of PRS-1 codes becomes equal to the channel capacity of the BEC.

VI. Performance Comparison with RS Codes

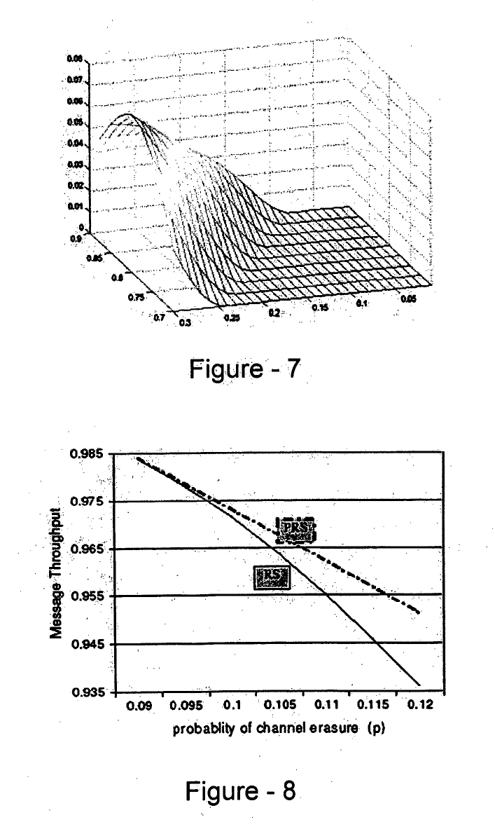

The z-axis in FIG. 7 shows the difference in performance of RS code and an optimal PRS code in terms of message throughput. Thus it can be clearly observed that near and above channel capacity the performance of PRS-1 code can be better (may be much better) than an RS code of a similar rate. Thus an adaptive scheme based on PRS codes can indeed improve the overall efficiency of the FEC scheme.

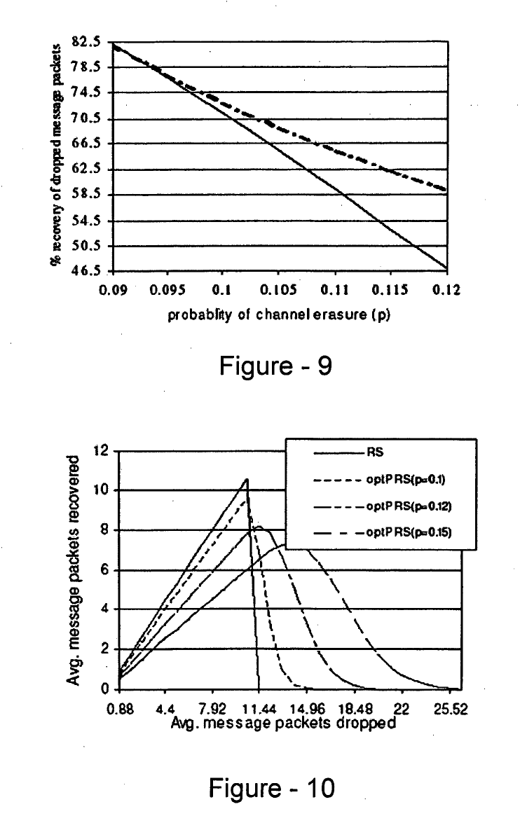

At this stage it is important to emphasize that, there exist coding rates below channel capacity for which an optimal PRS code can outperform an RS code of similar rate and blocklength. FIG. 8 shows an example for direct comparison of these codes. It can be clearly seen that that for coding rate of 0.88 and block-length of 100, if the channel capacity is lesser than approximately 0.905 then the optimal PRS code outperforms the classical RS code. FIG. 9 does an identical comparison, but based on % recovery of dropped message packets. Thus it is clearly illustrated that at coding rates near channel capacity a PRS codes facilitates a much improved recovery of erased information in comparison to a corresponding RS code. In FIG. 9 it can be observed that for coding rates almost equal to the channel capacity, PRS codes recover 13% more data than a similar RS code.

VII. Graceful Degradation

FIG. 10 shows the comparative performance of (100,88) codes of rate R=0.88 as a function of the number of packet losses (L). It should be noted that the avg. no. of message packets dropped=R·L. The performance of an RS code is compared with PRS-1 codes optimized for various erasure probabilities. It can be observed that when a RS code block experiences a number of losses that is larger than the number of parity symbols, then the code is incapable of recovering any of the lost message data. Experiencing a number of losses that is larger than the number of parity symbols is quite feasible, even if, “on average”, the message rate R is lower than the channel capacity. This is particularly true when the message rate R is close to (but may still be lower than) the channel capacity. On the contrary the performance of PRS-1 code shows a graceful degradation in performance. Depending on the channel conditions, this property can be suitably exploited to provide better packet recovery than an RS based FEC scheme. The above phenomenon is responsible for PRS-1 codes showing better performance than RS codes in FIGS. 8 and 9. Video simulations provided in the next section further illustrate the significance of a graceful degradation in performance.

VIII. Video Simulations

The overall performance due to the graceful degradation in performance of PRS codes, as the number of losses in a code block increase, is further highlighted when the performance is measured in terms of perceptual image quality instead of message throughput. This can be attributed to the limitations of error concealment algorithms, which are effective only when the numbers of losses (after channel decoding) is not substantial. The newly emerging JVT standard is used as an underlying video coding technique to compare the performance of RS and PRS channel coding schemes under identical channel conditions and identical loss patterns.

In the above experiments no knowledge about the source model was used for allocation of parity symbols i.e. the symbols to be protected in a PRS code block were chosen without taking into consideration the importance of I frames or the temporal proximity of P frames to a particular I frame. Thus no attempt is made to provide a new Prioritized Encoding scheme. Often Unequal Error Protection is associated with Prioritized Encoding schemes, but it should be noted that even irregular graph codes are unequal error protection schemes. Thus in this case the best PRS code for a BEC is an unequal distribution of parity. A more appropriate interpretation of such a code would be to recognize it as an irregular graph code. In addition the error robustness features in the standard were kept at a minimal. i.e. features such as forced intra coded blocks, data partitioning, use of B-frames etc. were turned off. Taking all the above features into consideration can significantly improve the performance of PRS codes, but even without these features and even for worst cases the performance improvement of PRS codes is significant.

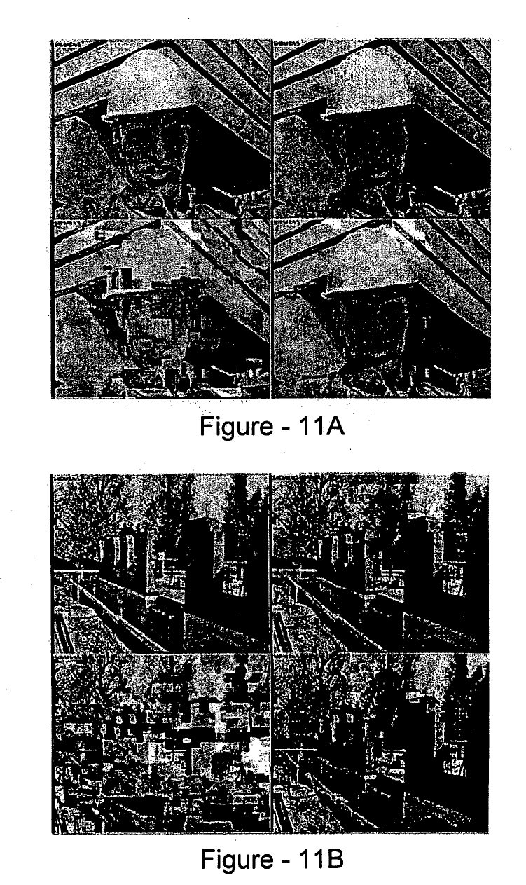

The standard test sequence foreman is employed to present results. The sequence was coded at 1 Mbps at 30 HZ. A Group-Of-Pictures (GOP) size of 15 with a frame sequence IPPP was used. A packet size of 512 bytes and slice size of 512 bytes were used for the purpose of the simulations. FIGS. 10 and 11 show instances in a particular ensemble of the simulations. Similar results were observed for numerous repetitions of the experiments. FIGS. 10 and 11 show the results obtained by using (100,88) RS and (100,88,72) PRS-1 (optimized for p=0.11) codes. When the number of losses in a code block is less than N-K the performance of RS codes is better than that of the PRS code. The difference in performance between the two schemes is the maximum when L=N−K. As against this the performance of a PRS code is better than an RS code when the number of losses are greater than N−K. The improvement due to a PRS code is the least significant when the number of losses L=N−K+1.

In the simulations, the number of losses in each code block was forced to be equal to some L. FIGS. 10 and 11 shown below present the results for the cases when L=N−K and L=N−K+1. Moreover for L=N−K these Figures show the comparison of the worst affected frames for a PRS coded sequence. Moreover, for L=N−K+1, comparison of frames when the improvement due to PRS codes is not exaggerated has been presented. Thus these Figures show the performance comparison of a RS and PRS for a “worst case scenario” for PRS.

It should be noted that there were many instances when a particular frame in an RS coded sequence was significantly distorted but a PRS coded sequence had absolutely no artifacts.

It can be clearly seen in the above mentioned Figures that when L=12 the image quality for an RS coded sequence is better than that of a PRS coded sequence. Nevertheless the distortion in the PRS coded sequence is not very significant. On the contrary the performance of the RS coded sequence when L=13 is much worse than that of the PRS code. It can be seen that though the quality of the image for a PRS sequence also deteriorates, the increase in distortion is not significant.

However the increase in distortion for an RS coded sequence is high enough to almost make the frame unintelligible. For such low quality images, the traditional Peak-Signal-to-Noise-Ratio (PSNR) measure does not reflect the true quality of the image and hence only visual results have been presented.

IX. Adaptive FEC

Over channels with time-varying characteristics, multiple code blocks can experience a number of losses that are larger than the number of parity symbols. (e.g., the Internet and wireless networks). Thus, though “on-average” coding rate is lesser than channel capacity, it is possible for the coding rate to be greater than the channel capacity for a period of time. If the change in channel conditions is slow enough and if a channel can provide some feedback information about the channel conditions, then the underlying error control code in an FEC scheme can be changed to adapt to the channel conditions. Most of the current FEC schemes adapt to the channel conditions by changing the coding rate R. If the loss probability increases, the number of parity symbols are also increased (thus the rate is adapted to always transmit below channel capacity). For a realtime application this is equivalent to increasing the transmission bit-rate. Increasing the transmission bit-rate is not always feasible and thus changing the coding rate in an adaptive FEC scheme is not always suitable.

Using a PRS code based adaptive FEC scheme can mitigate the above problem. In such a scheme the coding rate is kept fixed, but the underlying PRS-1 code can be changed. The feedback information about the erasure probability from the channel can be used to optimize the design of the underlying PRS-1 code. It should be noted that the coding rate of the PRS code could be greater than channel capacity for a limited period of time. Optimality analysis of PRS codes for such scenarios was provided in section 4. FIG. 13 shows a comparative analysis. It compares the performance of (100,88) PRS-1 codes optimized for different channel conditions, with the performance of (100,88) RS code. It can be observed that the PRS-1 codes perform significantly better than an RS code and can maintain more than 85% message throughput even when the coding rate is well above channel capacity.

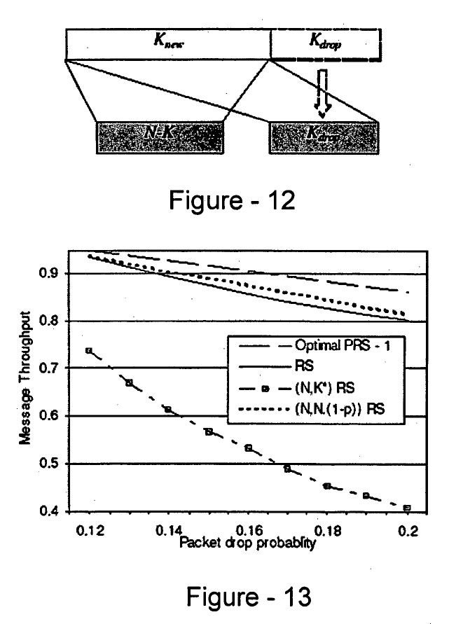

It should be realized though, that it is possible to design an RS based fixed transmission rate adaptive FEC scheme. This can be achieved by changing the rate of a code without changing the block-length and transmission rate as shown in FIG. 12. The two possible ways to achieve this are by:

(a) transmitting only a subset of K* message packets out of the K message packets and protecting these K* message packets by N−K* parity packets instead of N−K. Thus K−K* message packets are dropped at the source itself. The performance of this scheme is given by the following equation

$${p}_{m} = ( \frac{1}{K} ) \cdot ( \begin{matrix}( K - {K}^{*} ) + ( \frac{{K}^{*}}{{N}_{1}} ) \cdot \\ ( {\sum }_{i = δ + 1}^{{N}_{1}} i \cdot ( \begin{matrix}{N}_{1} \\ i\end{matrix} ) \cdot {p}^{i} \cdot {( 1 - p )}^{( {N}_{1} - i )} )\end{matrix} ) \\ where {N}_{1} = N - K + {K}^{*} and δ = {N}_{1} - {K}^{*} \qquad ( 5 )$$

(b) transmitting only a subset N·(1−p) message packets out of the K message packets and protecting these N·(1−p) message packets by N·p parity packets instead of N−K. Thus K−N (1−p) message packets are dropped at the source itself. The performance of such a scheme is given by

$${p}_{m} = ( \frac{1}{K} ) \cdot ( \begin{matrix}( K - {K}^{*} ) + ( 1 - p ) \cdot \\ ( {\sum }_{i = δ + 1}^{{N}_{1}} i \cdot ( \begin{matrix}{N}_{1} \\ i\end{matrix} ) \cdot {p}^{i} \cdot {( 1 - p )}^{( {N}_{1} - i )} )\end{matrix} ) \\ where {N}_{1} = N - K + {K}^{*} and δ = {N}_{1} - ⌈ N \cdot ( 1 - p ) ⌉ . \qquad ( 6 )$$

FIG. 13 shows that performance of scheme (a) is much worse than optimal PRS-1 code. The performance of (b) is better than RS code but still inferior to that of an optimal PRS code. The above results illustrate the feasibility of pursuing adaptive RS-based strategies that provide performance close (yet still inferior) to the optimal PRS-1 codes by optimally dropping packets before transmission and decreasing rate as described in scenarios (a) and (b). Nevertheless, these adaptive RS-based strategies may not be viable in some practical systems. For example, for many popular streaming applications, the source rate (presented by K/N), cannot be changed in realtime (e.g., because this represent the minimum bitrate of the “base-layer” video that the applications desire to transmit). Hence, dropping packets of the source material is certainly not desirable. Therefore, PRS-1 based solutions provide an attractive alternative that do not require changing the source rate while providing higher throughput. Furthermore, such a hypothetical adaptive RS-based scheme, on account of being an RS based scheme will not exhibit graceful degradation. As the feedback about channel conditions is an estimate over multiple code blocks, it is possible for an RS code to be ill designed for individual blocks. In such a event, the performance of a PRS-1 code will not deteriorate as rapidly as an RS based code.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A channel coding method for use with data transmitted over a network, comprising:
employing a block of symbols having a partition profile exhibiting a partition on a set of parity symbols and a partition on a set of message symbols.

2. The method of claim 1, further comprising identifying an optimal partition profile for a channel, including:
(a) employing a message throughput parameter τₘ to measure performance of the partition profile; and
(b) maximizing τₘ.

3. The method of claim 2, wherein maximizing τₘ includes minimizing a probability ρₘ of a message symbol loss (after channel decoding), wherein τₘ=(1−ρₘ).

4. The method of claim 3, further comprising:
keeping symbol block length and transmission rate fixed; and
using feedback information about a probability of erasure p from a channel to change the partition profile.

5. The method of claim 4, further comprising transmitting only a subset of K* message symbols out of K message symbols and protecting the K* message symbols by N−K* parity symbols, such that K−K* message symbols are dropped at a source.

6. The method of claim 5, further comprising calculating ρₘ according to:
$${p}_{m} = ( \frac{1}{K} ) \cdot ( \begin{matrix}( K - {K}^{*} ) + ( \frac{{K}^{*}}{{N}_{1}} ) \cdot \\ ( {\sum }_{i = δ + 1}^{{N}_{1}} i \cdot ( \begin{matrix}{N}_{1} \\ i\end{matrix} ) \cdot {p}^{i} \cdot {( 1 - p )}^{( {N}_{1} - i )} )\end{matrix} ) \\ where {N}_{1} = N - K + {K}^{*} and δ = {N}_{1} - {K}^{*} \qquad ( 5 )$$

7. The method of claim 4, further comprising transmitting only a subset N·(1−p) message symbols out of K message symbols and protecting the N·(1−p) message symbols by N·p parity symbols, such that K−N·(1−p) message symbols are dropped at a source.

8. The method of claim 7, further comprising calculating ρₘ according to:
$${p}_{m} = ( \frac{1}{K} ) \cdot ( \begin{matrix}( K - {K}^{*} ) + ( 1 - p ) \cdot \\ ( {\sum }_{i = δ + 1}^{{N}_{1}} i \cdot ( \begin{matrix}{N}_{1} \\ i\end{matrix} ) \cdot {p}^{i} \cdot {( 1 - p )}^{( {N}_{1} - i )} )\end{matrix} ) \\ where {N}_{1} = N - K + {K}^{*} and δ = {N}_{1} - ⌈ N \cdot ( 1 - p ) ⌉ . \qquad ( 6 )$$

9. The method of claim 1, wherein the partition profile is denoted by (N, K, Λₛ)_{q} where Λₛ represents a 2×(s+1) matrix given by:
$$[ \begin{matrix}{N}_{1} … {N}_{s + 1} \\ {K}_{1} … {K}_{s + 1}\end{matrix} ] ,$$
wherein N is a size of the block of symbols, K is a number of message symbols, and entries of matrix Λₛ are constrained according to:
$${N}_{i} > {K}_{i} ∀ i ∈ [ 1 , s ] , {K}_{i} > 0 ∀ i ∈ [ 1 , s ] , \\ {N}_{s + 1} = {K}_{s + 1} and N = {\sum }_{i} {N}_{i} , K = {\sum }_{i} {K}_{i} . \qquad ( 1 )$$

10. The method of claim 9, further comprising choosing a value K* for K₁ for a partition profile denoted by (N,K,K₁), which is equivalent to a partition profile denoted by (N,K,Λ₁) where
$${Λ}_{1} = [ \begin{matrix}N - K + {K}_{1} & K - {K}_{1} \\ {K}_{1} & K - {K}_{1}\end{matrix} ] .$$

11. The method of claim 10, further comprising choosing K to minimize a probability ρₘ of a message symbol loss (after channel decoding) for a (N,K,K₁) partition profile over a channel with probability of erasure p according to:
$${p}_{m} = ( \frac{1}{K} ) \cdot ( \begin{matrix}( K - {K}_{1} ) \cdot p + ( \frac{{K}_{1}}{( N - K ) + {K}_{1}} ) \cdot \\ ( {\sum }_{i = ( {N}_{1} - {K}_{1} ) + 1}^{{N}_{1}} i \cdot ( \begin{matrix}{N}_{1} \\ i\end{matrix} ) \cdot {p}^{i} \cdot {( 1 - p )}^{( {N}_{1} - i )} )\end{matrix} ) \\ where {N}_{1} = N - K + {K}_{1} . \qquad ( 4 )$$

12. The method of claim 9, further comprising determining an average total message throughput of an order s partition profile according to:
$${τ}_{m} = ( \frac{1}{K} ) \cdot {\sum }_{i = 1}^{s + 1} ρ ( {N}_{i} , {K}_{i} ) , \qquad ( 2 )$$
where, ρ(Nᵢ,Kᵢ) denotes an average number of message symbols received after channel decoding due to a single component of a code graph.

13. The method of claim 12, further comprising evaluating ρ(Nᵢ,Kᵢ) according to:
$$ρ ( {N}_{i} , {K}_{i} ) = ( {\sum }_{l = 0}^{{N}_{i} - {K}_{i}} {K}_{i} \cdot ( \begin{matrix}{N}_{i} \\ l\end{matrix} ) \cdot {p}^{l} \cdot {( 1 - p )}^{( {N}_{i} - l )} ) + ( {\sum }_{l = {N}_{i} - {K}_{i} + 1}^{{N}_{i}} ( {K}_{i} / {N}_{i} ) \cdot ( {N}_{i} - l ) \cdot {p}^{l} \cdot {( 1 - p )}^{( {N}_{i} - l )} ) . \qquad ( 3 )$$

14. The method of claim 1, further comprising employing an order 1 partition profile for a Binary Erasure Channel, wherein the partition profile is of order s, and exhibits a s-partition on the set of parity symbols and a (s+1)-partition on the set of message symbols.

15. An adaptive forward error correction method, comprising:
receiving feedback information about a probability of erasure p from a channel;
keeping a symbol block length and transmission rate fixed; and
changing an underlying partition profile for coding the channel based on the feedback information, wherein the channel is coded to have a block of symbols having the partition profile, and the partition profile exhibits a partition on a set of parity symbols and a partition on a set of message symbols.

16. The method of claim 15, further comprising transmitting a subset of K* message symbols out of K message packets and protecting the K* message symbols by N−K parity symbols, such that K−K* message symbols are dropped at a source.

17. The method of claim 16, further comprising maximizing a message throughput parameter τₘ, including minimizing a probability ρₘ of a message symbol loss (after channel decoding), wherein τₘ=(1−ρₘ), and ρₘ is calculated according to:
$${p}_{m} = ( 1 / K ) \cdot ( \begin{matrix}( K - {K}^{*} ) + ( {K}^{*} / {N}_{1} ) \cdot \\ ( {\sum }_{i = δ + 1}^{{N}_{1}} i \cdot ( \begin{matrix}{N}_{1} \\ i\end{matrix} ) \cdot {p}^{i} \cdot {( 1 - p )}^{( {N}_{1} - i )} )\end{matrix} ) \\ where {N}_{1} = N - K + {K}^{*} and δ = {N}_{1} - {K}^{*} . \qquad ( 5 )$$

18. The method of claim 15, further comprising transmitting only a subset N·(1−p) message symbols out of K message symbols and protecting these N·(1−p) message symbols by N·p parity symbols, such that K−N·(1−p) message symbols are dropped at a source.

19. The method of claim 18, further comprising maximizing a message throughput parameter τₘ, including minimizing a probability ρₘ of a message symbol loss (after channel decoding), wherein τₘ=(1−ρₘ), and ρₘ is calculated according to:
$${p}_{m} = ( 1 / K ) \cdot ( \begin{matrix}( K - {K}^{*} ) + ( 1 - p ) \cdot \\ ( {\sum }_{i = δ + 1}^{{N}_{1}} i \cdot ( \begin{matrix}{N}_{1} \\ i\end{matrix} ) \cdot {p}^{i} \cdot {( 1 - p )}^{( {N}_{1} - i )} )\end{matrix} ) \\ where {N}_{1} = N - K + {K}^{*} and δ = {N}_{1} - ⌈ N \cdot ( 1 - p ) ⌉ . \qquad ( 6 )$$

20. The method of claim 15, further comprising employing a partition profile of order s having an s-partition on the set of parity symbols and a (s+1)-partition on the set of message symbols.

21. The method of claim 20, wherein the partition profile is denoted by (N, K, Λₛ)_{q} where Λₛ represents a 2×(s+1) matrix given by:
$$[ \begin{matrix}{N}_{1} … {N}_{s + 1} \\ {K}_{1} … {K}_{s + 1}\end{matrix} ] ,$$
wherein N is message symbol block size, K is a number of message symbols, and entries of matrix Λₛ are constrained according to:
$${N}_{i} > {K}_{i} ∀ i ∈ [ 1 , s ] , {K}_{i} > 0 ∀ i ∈ [ 1 , s ] , \\ {N}_{s + 1} = {K}_{s + 1} and N = {\sum }_{i} {N}_{i} , K = {\sum }_{i} {K}_{i} . \qquad ( 1 )$$

22. The method of claim 21, further comprising choosing a value K* for K₁ for a partition profile denoted by (N,K,K₁), which is equivalent to a partition profile denoted by (N,K,Λ₁) where
$${Λ}_{1} = [ \begin{matrix}N - K + {K}_{1} & K - {K}_{1} \\ {K}_{1} & K - {K}_{1}\end{matrix} ] .$$

23. The method of claim 22, further comprising choosing K* to minimize a probability ρₘ of a message symbol loss (after channel decoding) for a (N,K,K₁) partition profile over a channel with probability of erasure p according to:
$${p}_{m} = ( 1 / K ) \cdot ( \begin{matrix}( K - {K}_{1} ) \cdot p + ( \frac{{K}_{1}}{( N - K ) + {K}_{1}} ) \cdot \\ ( {\sum }_{i = ( {N}_{1} - {K}_{1} ) + 1}^{{N}_{1}} i \cdot ( \begin{matrix}{N}_{1} \\ i\end{matrix} ) \cdot {p}^{i} \cdot {( 1 - p )}^{{N}_{1} - i} )\end{matrix} ) \\ where {N}_{1} = N - K + {K}_{1} \qquad ( 4 )$$

24. The method of claim 21, further comprising determining an average total message throughput of an order s partition profile according to:
$${τ}_{m} = ( \frac{1}{K} ) \cdot {\sum }_{i = 1}^{s + 1} ρ ( {N}_{i} , {K}_{i} ) \qquad ( 2 )$$
where, ρ(Nᵢ,Kᵢ) denotes an average number of message symbols received after channel decoding due to a single component of a code graph.

25. The method of claim 24, further comprising evaluating ρ(Nᵢ,Kᵢ) according to:
$$ρ ( {N}_{i} , {K}_{i} ) = ( {\sum }_{l = 0}^{{N}_{i} - {K}_{i}} {K}_{i} \cdot ( \begin{matrix}{N}_{i} \\ l\end{matrix} ) \cdot {p}^{l} \cdot {( 1 - p )}^{( {N}_{i} - l )} ) + ( {\sum }_{l = {N}_{i} - {K}_{i} + 1}^{{N}_{i}} ( {K}_{i} / {N}_{i} ) \cdot ( {N}_{i} - l ) \cdot {p}^{l} \cdot {( 1 - p )}^{( {N}_{i} - l )} ) . \qquad ( 3 )$$

26. The method of claim 21, further comprising employing an order 1 partition profile for a Binary Erasure Channel, wherein the partition profile is of order s, and exhibits a s-partition on a set of parity symbols and a (s+1)-partition on a set of message symbols.

27. A data source, comprising:
an input receiving feedback information about a probability of erasure p from a channel;
a channel coding module employing a block of symbols having a partition profile exhibiting a partition on a set of parity symbols and a partition on a set of message symbols; and
an adaptive forward error correction module keeping message symbol block length and transmission rate fixed while changing the partition profile based on the feedback information.

28. The streaming media source of claim 27, wherein said adaptive forward error correction module transmits only a subset of K* message symbols out of K message symbols and protects these K* message symbols by N−K* parity symbols, such that K−K* message symbols are dropped at the source.

29. The streaming media source of claim 27, wherein said adaptive forward error correction module transmits only a subset N·(1−p) message symbols out of K message symbols and protects these N·(1−p) message symbols by N·p parity symbols, such that K−N·(1−p) message symbols are dropped at the source.

30. The streaming media source of claim 27, wherein said channel coding module employs an order 1 partition profile for a Binary Erasure Channel, wherein the partition profile is of order s, and exhibits a s-partition on the set of parity symbols and a (s+1)-partition on the set of message symbols.

31. A computer program stored in a data storage medium, comprising:
channel coding instructions employing a block of symbols having a partition profile exhibiting a partition on a set of parity symbols and a partition on a set of message symbols.

32. The computer program of claim 31, further comprising:
adaptive forward error correction instructions keeping message symbol block length and transmission rate fixed while changing the partition profile based on feedback information about a probability of erasure p relating to a channel.

33. The computer program of claim 32, further comprising:
partition profile optimizing instructions employing a message throughput parameter τₘ to measure performance of the partition profile respective of a channel having a probability ρₘ of a message symbol loss (after channel decoding), and maximizing τₘ by minimizing ρₘ, wherein τₘ=(1−ρₘ);
average total message throughput calculation instructions calculating average total message throughput of a partition profile according to:
$${τ}_{m} = ( \frac{1}{K} ) \cdot {\sum }_{i = 1}^{s + 1} ρ ( {N}_{i} , {K}_{i} ) \qquad ( 2 )$$
where K denotes a number of message symbols in the block of message symbols, and ρ(Nᵢ,Kᵢ) denotes an average number of message symbols received after channel decoding due to a single component of a code graph; and
average number of message symbols received calculation instructions calculating ρ(Nᵢ,Kᵢ) according to:
$$ρ ( {N}_{i} , {K}_{i} ) = ( {\sum }_{l = 0}^{{N}_{i} - {K}_{i}} {K}_{i} \cdot ( \begin{matrix}{N}_{i} \\ l\end{matrix} ) \cdot {p}^{l} \cdot {( 1 - p )}^{( {N}_{i} - 1 )} ) + ( {\sum }_{l = {N}_{i} - {K}_{i} + 1}^{{N}_{i}} ( {K}_{i} / {N}_{i} ) \cdot ( {N}_{i} - l ) \cdot {p}^{l} \cdot ( 1 - {p}^{( {N}_{i} - 1 )} ) ) \qquad ( 3 )$$

34. The computer program of claim 33, further comprising:
message symbol transmission instructions transmitting only a subset of K* message symbols out of K message symbols and protecting these K* message symbols by N−K* parity symbols, such that K−K* message symbols are dropped at the source.

35. The computer program of claim 33, further comprising:
message symbol transmission instructions transmitting only a subset N·(1−p) message symbols out of K message symbols and protecting these N·(1−p) message symbols by N·p parity symbols, such that K−N·(1−p) message symbols are dropped at the source.

36. A data stream propagating through a channel of a network, comprising:
a first plurality of blocks of message symbols having a partition profile exhibiting a partition on a set of parity symbols. and a partition on a set of message symbols.

37. The stream of claim 36, wherein the partition profile is optimized for a probability of erasure p relating to the channel.

38. The stream of claim 37, wherein the partition profile is denoted by (N, K, Λₛ)_{q} where Λₛ represents a 2×(s+1) matrix given by:
$$[ \begin{matrix}{N}_{1} … {N}_{s + 1} \\ {K}_{1} … {K}_{s + 1}\end{matrix} ] ,$$
wherein N is a size of the block of symbols, K is a number of message symbols, and entries of matrix Λₛ are constrained according to:
$${N}_{i} > {K}_{i} ∀ i ∈ [ 1 , s ] , {K}_{i} > 0 ∀ i ∈ [ 1 , s ] , \\ {N}_{s + 1} = {K}_{s + 1} and N = {\sum }_{i} {N}_{i} , K = {\sum }_{i} {K}_{i} . \qquad ( 1 )$$

39. The stream of claim 38, wherein K₁ has a value K* for a partition profile denoted by (N,K,K₁), which is equivalent to a partition profile denoted by (N,K,Λ₁) where
$${Λ}_{1} = [ \begin{matrix}N - K + {K}_{1} & K - {K}_{1} \\ {K}_{1} & K - {K}_{1}\end{matrix} ] .$$

40. The stream of claim 39, wherein K* minimizes a probability ρfm of a message symbol loss (after channel decoding) for a (N,K,K₁) partition profile over a channel with probability of erasure p according to:
$${p}_{m} = ( 1 / K ) \cdot ( \begin{matrix}( K - {K}_{1} ) \cdot p + ( \frac{{K}_{1}}{( N - K ) + {K}_{1}} ) \cdot \\ ( {\sum }_{i = ( {N}_{1} - {K}_{1} ) + 1}^{{N}_{1}} i \cdot ( \begin{matrix}{N}_{1} \\ i\end{matrix} ) \cdot {p}^{i} \cdot {( 1 - p )}^{{N}_{1 - i}} )\end{matrix} ) \\ where {N}_{1} = N - K + {K}_{1} \qquad ( 4 )$$

41. The stream of claim 36, wherein the channel is a Binary Erasure Channel, and the partition profile is an order s partition profile of first order exhibiting a s-partition on the set of parity symbols and a (s+1)-partition on the set of message symbols.

42. The stream of claim 36, further comprising:
a second plurality of blocks of message symbols subsequent to the first plurality of blocks of message symbols, wherein blocks of the second plurality exhibit identical block length and transmission rate as blocks of the first plurality, and a partition profile of the blocks of the second plurality is different from the partition profile of the first plurality.
